(19) United States
(12) Patent Application Publication
(10) Pub. No.: US 2012/0249968 A1
(43) Pub. Date: Oct. 4, 2012

(54) AUTOSTEREOSCOPIC DISPLAY

(75) Inventors: Takafumi Koike, Tokyo (JP); Michio Oikawa, Tokyo (JP); Masami Yamasaki, Tokyo (JP)

(73) Assignee: HITACHI CONSUMER ELECTRONICS CO., LTD., Tokyo (JP)

(21) Appl. No.: 13/292,391

(22) Filed: Nov. 9, 2011

(30) Foreign Application Priority Data
Mar. 29, 2011 (JP) 2011-072210

(51) Int. Cl. G02B 27/22; G03B 21/00

(52) U.S. Cl. 353/7; 359/462; 359/463

(57) ABSTRACT

A light beam projected from a projector passes through a microlens and then is focused on an extremely small region (hereinafter, will be called a deflection point). After that, the light beam is diverged as a directional light beam from the region serving as the deflection point. Thus, a viewer of a stereoscopic display perceives light beams as extremely small pixels. In reality, the deflection points are largely spaced, so that a rough image is perceived by a viewer who observes a screen. An autostereoscopic display including a two-dimensional image display device and an optical element, the optical element having a structure that simultaneously diffuses and deflects light emitted from the two-dimensional image display device, so that a stereoscopic image is displayed.

### INCORPORATION BY REFERENCE

The present application claims priority from Japanese application Ser. No. 2011-072210, filed on Mar. 29, 2011, the entire contents of which are hereby incorporated by reference into this application.

### BACKGROUND

1. Field of the Invention

The present invention relates to an autostereoscopic display.

2. Description of the Related Art

Japanese Patent Laid-Open No. 2008-139524, which is a background art of the field of the invention, discloses a technique in which light beams projected from projectors are deflected through a microlens array and then are diverged as directional light beams. Thus, different light beams are incident on the left and right eyes of a viewer and are perceived as a stereoscopic image. Such a technique of deflecting light beams in some way allows a viewer to perceive the deflected light beams, enabling stereoscopy. In this case, “deflection” means a change of the travel direction of light. Generally, in a microscopic observation, light passing through a substance is scattered by atoms or molecules constituting the substance, or the light is diffracted by a structurally discontinuous part, whereas in a macroscopic observation, diffused or refracted light is observed.

In Japanese Patent Laid-Open No. 2008-139524, a light beam projected from a projector passes through a microlens and then is focused on an extremely small region (hereinafter, will be called a deflection point). After that, the light beam is diverged as a directional light beam from the region serving as the deflection point. Thus, a stereoscopic image is perceived by a viewer of a stereoscopic display, and light beams focused on the deflection point are perceived as extremely small pixels.

### SUMMARY

Ideally, projectors are sufficiently dense and adjacent deflection points are sufficiently close to each other. In reality, projectors and deflection points are largely spaced, so that a rough image is perceived by a viewer who observes a screen. In the case where the pixel spacing is perceived in this way, unfortunately, a large number of pixels are perceived with a lessened stereoscopic effect and lower image quality.

The present invention provides an autostereoscopic display that can display a smooth stereoscopic image with an enhanced stereoscopic effect and improved image quality without densely arranging projectors.

In order to attain the object, the present invention is an autostereoscopic display including a two-dimensional image display device and an optical element that simultaneously diffuses and deflects light from the two-dimensional image display to display a stereoscopic image.

The present invention can provide an autostereoscopic display that can display a smooth stereoscopic image with an enhanced stereoscopic effect and improved image quality.

Other problems, configurations, and effects will be apparent from the following detailed description of the invention.

### BRIEF DESCRIPTION OF THE DRAWINGS

FIG. 1 illustrates an example of a structural diagram of an autostereoscopic display;

FIG. 2 illustrates an example of an optical element;

FIG. 3 illustrates an example of the optical element;

FIG. 4 illustrates an example of the optical element;

FIG. 5 illustrates an example of the optical element;

FIG. 6 illustrates an example of the optical element;

FIG. 7 illustrates an example of the optical element;

FIG. 8 illustrates an example of the optical element;

FIG. 9 illustrates an example of a structural diagram of the autostereoscopic display; and

FIG. 10 illustrates an example of a structural diagram of the autostereoscopic display.

### DETAILED DESCRIPTION OF THE EMBODIMENTS

Embodiments will be described below with reference to the accompanying drawings.

### First Embodiment

The present embodiment will describe an example of an autostereoscopic display that includes an optical element array having a diffusion effect and a deflection effect.

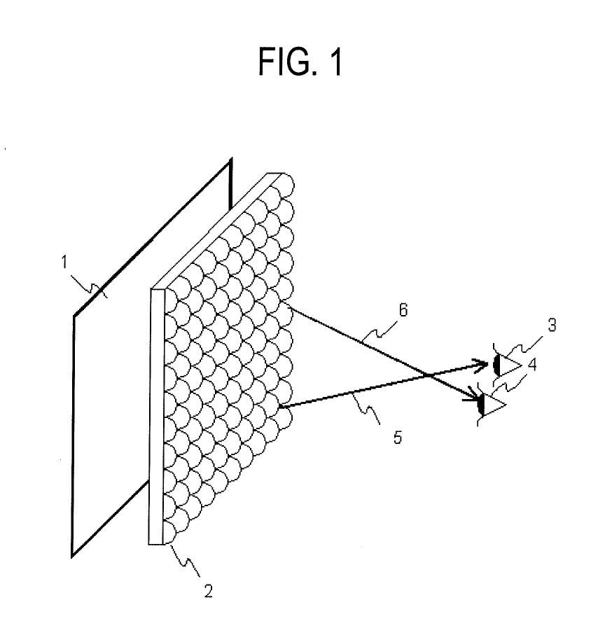

FIG. 1 illustrates an example of a structural diagram of the autostereoscopic display according to the present embodiment. The autostereoscopic display includes a two-dimensional image display device 1 and an optical element 2.

Light beams emitted from the two-dimensional image display device 1 are deflected by the optical element 2. When a user observes the display from the right side of

FIG. 1, different light beams 5 and 6 are incident on a right eye 3 and a left eye 4, respectively. The light beams with different colors and luminances are incident on the right eye 3 and the left eye 4, achieving a stereoscopic view with naked eyes. The two-dimensional image display device 1 may be a typical image display device, for example, a liquid crystal display, a plasma display, an organic EL display, a field emission display, or a projector.

The optical element 2 has multiple unit optical elements. Generally, the unit optical elements are arranged according to a rule. For example, the optical axes of the unit optical elements are arranged in a grid-like fashion or are aligned with the centers of closest packed structures. In this case, the optical axis is a straight line that passes through the center of the unit optical element perpendicularly to the incidence plane of the unit optical element. In the case where the unit optical element is a lens, the optical axis is a straight line that passes through the center of the lens perpendicularly to a lens surface.

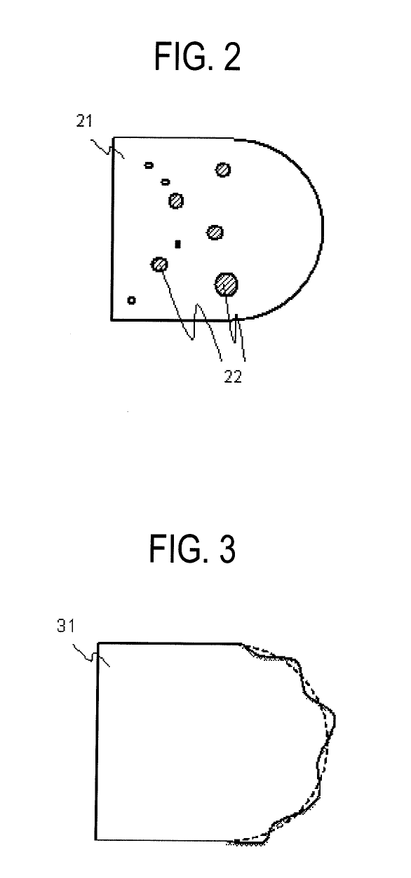

FIG. 2 is a cross-sectional view of the structure of the unit optical element taken along a plane including the optical axis of the unit optical element.

A unit optical element 21 contains diffusion elements 22. The unit optical element 21 is generally called a lens that is made of a material having a refractive index between 1 and 2 for visible light and a transmittance of at least 50% for visible light. Typically, one side of the unit optical element 21 has a hemispherical face and the other side has a flat surface. Both sides of the unit optical element 21 may be spherical.

Generally, in related art, the unit optical element 21 is obtained by bonding a diffuser panel of a rectangular solid and a hemispherical lens. Moreover, light is scattered only by the rectangular solid or over the rectangular solid and the hemisphere to deflect light on the boundary surface of the hemisphere.

The diffusion elements 22 are particles of different sizes which have the function of diffusing light over the elements by scattering light. The diffusion element 22 is sufficiently smaller than the unit optical element 21 (the order of the wavelength of visible light).

FIG. 3 illustrates another example of the structure of the unit optical element.

A unit optical element 31 has a spherical surface on one side and a flat surface on the other side. The spherical surface is randomly deformed up to about 10% of the radius of curvature of the original spherical surface. In this case, “randomly” means “irregularly”. For example, random numbers generated by a random number generating program of a computer may be used. The random deformation leads to random refraction of light beams on the boundary surface of the spherical surface on one side, causing scattering of light. Consequently, the structure of FIG. 3 has the scattering effect of the deformation and the deflection effect of the spherical surface.

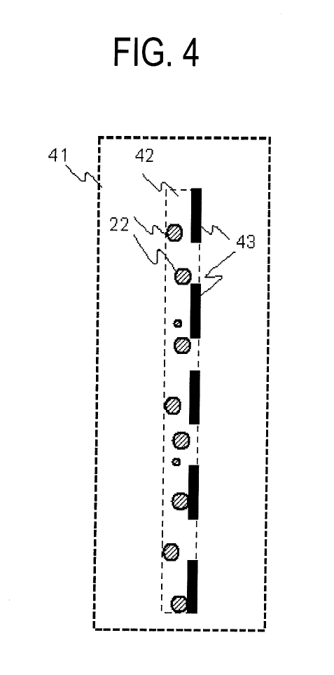

FIG. 4 illustrates another example of the structure of the unit optical element.

A unit optical element 41 includes a transmissive part 42, non-transmissive parts 43, and the diffusion elements 22. The transmissive part 42 and the diffusion elements 22 are not completely separated from each other and the diffusion elements 22 are embedded partially in the transmissive part 42. An interval between the adjacent non-transmissive parts 43 is at least several times as long as the wavelength of visible light. The non-transmissive parts 43 constitute a diffractive lens that deflects light in a specific direction.

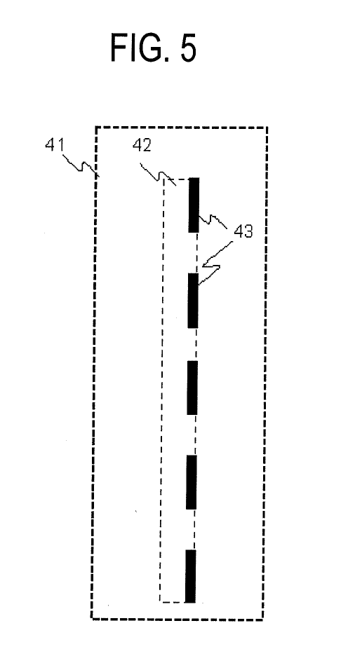

FIG. 5 illustrates another example of the structure of the unit optical element.

The unit optical element 41 includes the transmissive part 42 and the non-transmissive parts 43. An interval between the adjacent non-transmissive parts 43 is randomly varied by about 10% relative to a reference length. The variation in interval is sufficiently larger than the wavelength range of visible light. The non-transmissive parts 43 constitute a refractive lens that deflects light in a specific direction.

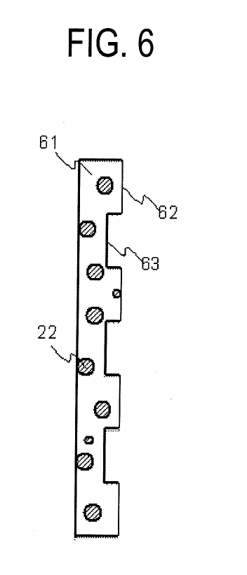

FIG. 6 illustrates another example of the structure of the unit optical element.

A unit optical element 61 includes multiple convex parts 62, multiple concave parts 63, and the diffusion particles 22. The convex parts 62 and the concave parts 63 are each made of a single material. The diffusion particles 22 are contained in the unit optical element. Diffracted waves of light are generated from a discontinuous part on the boundary between the convex parts 62 and the concave parts 63, so that the overall element constitutes a refractive lens that deflects light in a specific direction.

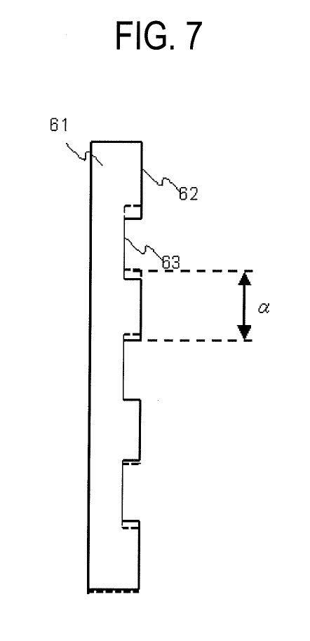

FIG. 7 illustrates another example of the structure of the unit optical element.

The unit optical element 61 includes the convex parts 62 and the concave parts 63. The widths of the convex parts 62 and the concave parts 63 are randomly varied by about 10% relative to a reference length a of the convex part 62 and the concave part 63. As in the structure of FIG. 5, the random variation in the width of the convex part 62 and the concave part 63 relative to the reference length a is sufficiently larger than the wavelength range of visible light. The convex parts 62 and the concave parts 63 constitute a refractive lens that deflects light in a specific direction.

The structures of FIGS. 2 to 8 will be summarized below.

The optical element 2 including the unit optical elements of FIGS. 2 and 3 is a hemispherical lens array that deflects light with hemispherical shapes. The optical element 2 including the unit optical elements of FIGS. 4 and 5 is an amplitude-type diffraction grating lens that deflects light by controlling the transmission of light, that is, the amplitude of light by means of the transmissive parts and the non-transmissive parts. The optical element 2 including the unit optical elements of FIGS. 6 and 7 is a phase-type diffraction grating lens that deflects light by controlling the transmission path difference of light, that is, the phase of light by means of the convex parts and the concave parts. The optical element 2 including the unit optical elements of FIGS. 2, 4 and 6 diffuses light by means of the multiple diffusion elements contained in the unit optical elements. The optical element 2 including the unit optical elements of FIGS. 3, 5 and 7 diffuses light by randomly changing the dimensions of structures on the surfaces of the unit optical elements.

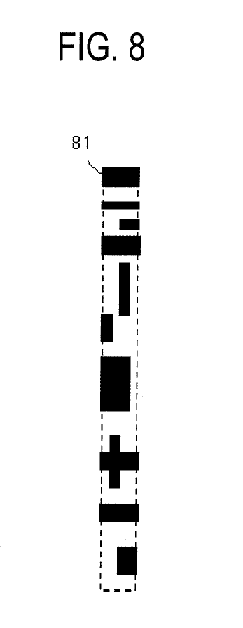

FIG. 8 illustrates another example of the structure of the unit optical element.

A unit optical element 81 is a computer synthesis hologram. The unit optical element 81 is, for example, a hologram pattern formed on a special film. While a diffraction grating has a fixed pattern, the computer synthesis hologram may have any pattern. The hologram of FIG. 8 scatters incident light and emits deflected light.

According to the embodiment of the present invention, the optical element can reduce moire that depends upon the periods of the pixels of a two-dimensional image display and the unit optical elements of the optical element, thereby improving the quality of a stereoscopic image.

### Second Embodiment

The present embodiment will describe an example of a projector-type autostereoscopic display including an optical element array having a diffusion effect and a deflection effect.

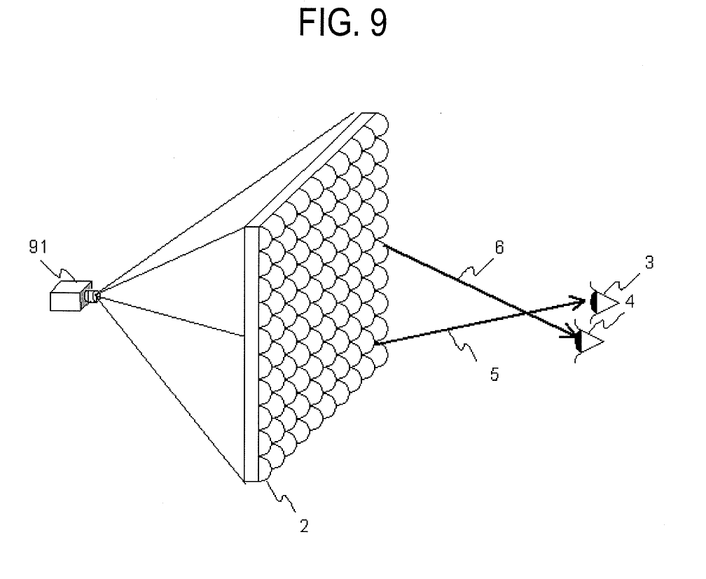

FIG. 9 is a structural diagram illustrating the autostereoscopic display of the present embodiment.

The two-dimensional image display device 1 of FIG. 1 is replaced with a projector 91. Other configurations indicated by the same reference numerals as those of FIG. 1 have the same functions and thus the explanation thereof is omitted.

A main difference from the configuration of FIG. 1 is that a distance between the projector 91 and an optical element 2 is longer than that between the two-dimensional image display device 1 and the optical element 2 of FIG. 1.

Typically, a distance between the two-dimensional image display device 1 and the optical element 2 of the first embodiment is substantially equal to a focal distance f of the optical element, whereas in the configuration of FIG. 9, a distance between the projector 91 and the optical element 2 is substantially equal to a focal distance f′ of the projector 91. Usually, f′>f is satisfied.

Also in the present embodiment, the optical element 2 of FIG. 9 may have the structures of FIGS. 4 to 8 or the unit optical elements constituting the optical element 2 may have the structures of FIGS. 2 and 3.

### Third Embodiment

The present embodiment will describe an example of a multiple-projector autostereoscopic display that includes an optical element array having a diffusion effect and a deflection effect.

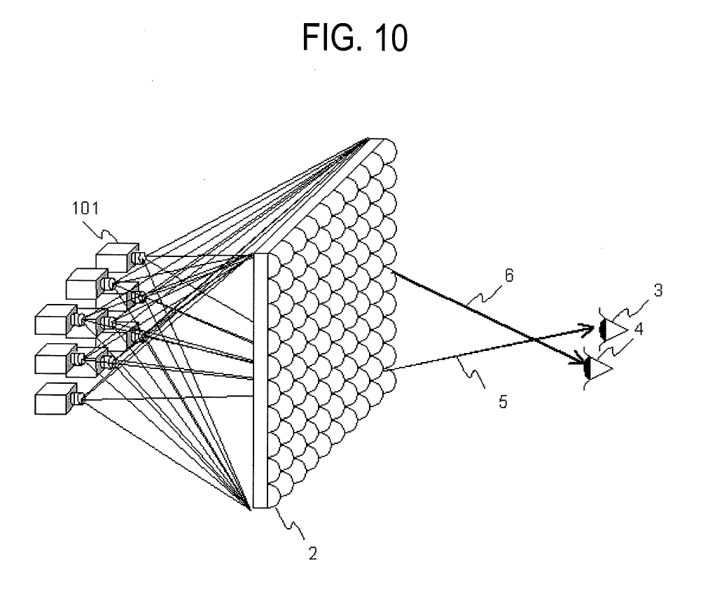

FIG. 10 is a structural diagram showing the autostereoscopic display of the present embodiment.

The two-dimensional image display device 1 of FIG. 1 is replaced with projectors 101. Other configurations indicated by the same reference numerals as those of FIG. 1 have the same functions and thus the explanation thereof is omitted. Also in the present embodiment, an optical element 2 of FIG. 10 may have the structures of FIGS. 4 to 8 or unit optical elements constituting the optical element 2 may have the structures of FIGS. 2 and 3.

In this configuration, the use of the multiple projectors improves the brightness of an image and increases the number of light beams so as to achieve higher image quality. Moreover, the optical element having the diffusion effect can expand pixel shapes so as to properly combine light beams emitted from the adjacent projectors, thereby displaying a smooth and natural stereoscopic image.

The present invention is not limited to these embodiments and thus may be modified in various ways. For example, the configurations of the embodiments specifically described to illustrate the present invention are not intended to limit the scope of the present invention. Moreover, the configuration of one of the embodiments may be partially replaced with the configurations of the other embodiments. To the configuration of one of the embodiments, the configurations of the other embodiments may be added. Furthermore, the addition, deletion, and replacement of configurations are possible partially in the configurations of the embodiments.

What is claimed is:

1. An autostereoscopic display comprising a two-dimensional image display device and an optical element, the optical element including a plurality of unit optical elements, each having a structure that simultaneously diffuses and deflects light emitted from the two-dimensional image display device.

2. The autostereoscopic display according to claim 1, wherein the unit optical element constituting the optical element is a hemispherical lens and contains diffused particles.

3. The autostereoscopic display according to claim 1, wherein the unit optical element constituting the optical element is a hemispherical lens having a spherical surface that is randomly deformed up to 10% of a radius of curvature of the spherical surface.

4. The autostereoscopic display according to claim 1, wherein the unit optical element constituting the optical element is an amplitude-type diffraction grating lens including a transmissive part and a non-transmissive part, and the transmissive part of the unit optical element contains diffused particles.

5. The autostereoscopic display according to claim 1, wherein the unit optical element constituting the optical element is an amplitude-type diffraction grating lens including a transmissive part and a non-transmissive part, and the non-transmissive part of the unit optical element has a length that is varied by up to 10%.

6. The autostereoscopic display according to claim 1, wherein the unit optical element constituting the optical element is a phase-type diffraction grating lens including a convex part and a concave part, and the unit optical element contains diffused particles.

7. The autostereoscopic display according to claim 1, wherein the unit optical element constituting the optical element is a phase-type diffraction grating including a convex part and a concave part, and the convex part and the concave part of the unit optical element each have a length that is varied by up to 10%.

8. The autostereoscopic display according to claim 1, wherein the unit optical element constituting the optical element is a computer synthesis hologram.

9. The autostereoscopic display according to claim 2, wherein the two-dimensional image display device is a projector.

10. The autostereoscopic display according to claim 2, wherein the two-dimensional image display device includes a plurality of projectors.
